(19) United States
(12) Patent Application Publication
(10) Pub. No.: US 2005/0090994 A1
(43) Pub. Date: Apr. 28, 2005

(54) Computing a residue fingerprint for a molecular structure

(75) Inventor: David Mosenkis, Philadelphia, PA (US)

Correspondence Address: STERNE, KESSLER, GOLDSTEIN & FOX PLLC, 1100 NEW YORK AVENUE, N.W., WASHINGTON, DC, 20005, US

(73) Assignee: Locus Pharmaceuticals, Inc.

(21) Appl. No.: 10/702,086

(22) Filed: Nov. 6, 2003

Related U.S. Application Data
(60) Provisional application No. 60/514,008, filed on Oct. 27, 2003.

(51) Int. Cl. G06F 19/00

(52) U.S. Cl. 702/27

(57) ABSTRACT

A method, system, and computer program product are provided to develop a residue fingerprint for a molecular structure (such as a ligand). Based on the residues of a reference structure (such as a protein), a residue fingerprint defines a set of residues that interacts with the molecular structure. Residue fingerprints can be used to compare different poses of a molecular structure with a reference pose of the same molecular structure, poses of different molecular structures, and/or a different reference three-dimensional structure. Fingerprints are used to define the similarity of structures in terms of binding mode, identify molecules with similar binding modes, or select a subset of molecules that represent the full diversity of binding modes in a larger set. Fingerprints are computed by a van der Waals-based process, and expressed as a list of interacting residues or a binary string representation.

### CROSS-REFERENCE TO RELATED APPLICATIONS

This application claims the benefit of U.S. Provisional Application No. 60/514,008, filed Oct. 27, 2003, by Mosenkis et al., entitled “Computing a Residue Fingerprint for a Molecular Structure,” incorporated herein by reference in its entirety.

### BACKGROUND OF THE INVENTION

1. Field of the Invention

The present invention relates generally to molecular analysis, and more specifically, to characterizing a molecule.

2. Related Art

Characterizing or distinguishing molecules has many practical benefits. For example, some molecules are known to react with a protein in a certain way. Being able to identify those molecules, researchers and practitioners can influence the migration of proteins within a living organism as well as develop new medications or treatments for diseases.

For instance, if a particular molecule is known to bind to specific residue sites on a protein, the protein may fold or enter a dormant or harmless state. As a result, the folded or dormant protein will be unable to bind to areas of a human heart or other organs, and cause damage to the heart or other organs.

Therefore, a need exists to develop a technology that can quickly and conveniently characterize, distinguish, and/or cluster molecules based on their interaction with a protein or similar structure.

### SUMMARY OF THE INVENTION

The present invention provides a method, system and computer program product for developing a residue fingerprint for a molecular structure (such as a ligand). Based on the residues of a reference structure (such as a protein), a residue fingerprint defines a set of residues that interacts with the molecular structure. Residue fingerprints can be used to compare different poses of the molecular structure with a reference pose on the same molecular structure, poses of different molecular structures, and/or a different reference three-dimensional structure.

In an embodiment, a list of molecular structures is generated and stored for characterization. Each molecular structure compared to a reference structure to characterize its binding mode with the reference structure.

In an embodiment, the binding mode is determined by measuring the inter-atomic distance between the molecular structure and residues on the reference structure. Interacting residues are identified as those having an inter-atomic distance that does not exceed an inter-atomic threshold. In an embodiment, the inter-atomic threshold is based on the van der Waals radii of the two atoms.

A residue fingerprint for the molecular structure is produced from interacting residues. In an embodiment, the residue fingerprint is expressed as a list of interacting residues. In another embodiment, the residue fingerprint is represented as a bit string whose length is the number or residues in the reference structure. The bit string can be a binary representation with a “1” designating positions corresponding to interacting residues and a “0” designating positions corresponding to non-interacting residues.

According to embodiments of the present invention, residue fingerprints are used to define the similarity of molecular structures in terms of binding mode, identify molecules with similar binding modes, and/or select a subset of molecules that represent the full diversity of binding modes in a larger set. In an embodiment, a Tanimoto score is computed to measure the similarity.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable one skilled in the pertinent art(s) to make and use the invention. In the drawings, generally, like reference numbers indicate identical or functionally or structurally similar elements. Additionally, generally, the leftmost digit(s) of a reference number identifies the drawing in which the reference number first appears.

FIG. 1 illustrates an operational flow for computing a residue fingerprint for a molecular structure according to an embodiment of the present invention.

FIG. 2 illustrates an operational flow for measuring interaction between a molecular structure and a reference structure according to an embodiment of the present invention.

FIG. 3 illustrates an operational flow for measuring interaction between a molecular structure and a reference structure according to another embodiment of the present invention.

FIG. 4 illustrates an operational flow for measuring interaction between a molecular structure and a reference structure according to another embodiment of the present invention.

FIG. 5 illustrates an operational flow for measuring interaction between a molecular structure and a reference structure according to another embodiment of the present invention.

FIG. 6 illustrates an operational flow for measuring similarities between two molecular structures according to an embodiment of the present invention.

FIG. 7 illustrates a comparison of residue fingerprints at analogous binding sites in a protein complex, according to an embodiment of the present invention.

FIG. 8 illustrates a comparison of residue fingerprints at analogous binding sites across related proteins, according to an embodiment of the present invention.

FIG. 9 illustrates an example computer system useful for implementing portions of the present invention.

### DETAILED DESCRIPTION OF THE INVENTION

According to embodiments of the present invention, a residue fingerprint is developed to characterize, distinguish, and cluster large numbers of three-dimensional molecular structures (such as, a ligand), based on their binding mode with a reference structure. A binding mode represents the three-dimensional interactions that a molecular structure makes with the reference structure. The reference structure can be a protein or any other type of macromolecule.

Based on the residues of the reference structure, a residue fingerprint defines a set of residues that interacts with the molecular structure. As discussed below, residue fingerprints can be used to define the similarity of structures in terms of binding mode, identify molecular structures with similar binding modes, or select a subset of molecular structures that represent the full diversity of binding modes in a larger set.

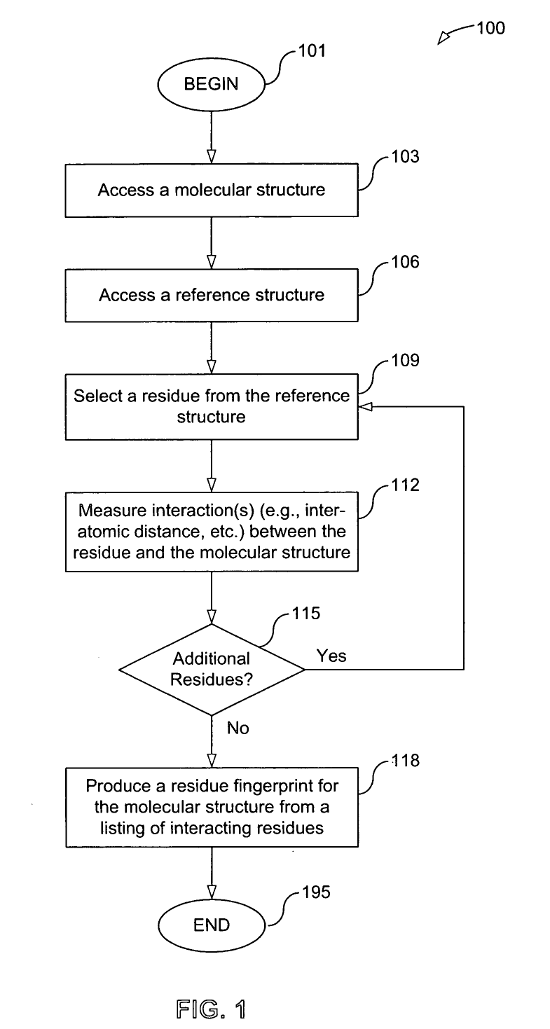

Referring to FIG. 1, flowchart 100 represents the general operational flow of an embodiment of the present invention. More specifically, flowchart 100 shows an example of a control flow for characterizing a three-dimensional molecular structure.

The control flow of flowchart 100 begins at step 101 and passes immediately to step 103. At step 103, a molecular structure is accessed for characterization. In an embodiment, the molecular structure is selected from a list of molecular structures, which are stored on a storage medium. In an embodiment, a software application is used build the list of molecular structures. For example, a software application can be used to design a group of molecular structures, which are based on a caspase protein structure. The molecular structures would be stored and selected individually to be characterized in accordance with the present invention.

At step 106, a reference structure is accessed. As discussed in greater detail below, the molecular structure selected at step 103 is compared to the reference structure to characterize its binding mode. As discussed above, the reference structure can be a protein or another macromolecule. If the selected molecular structure is generated by a software application from a caspase protein structure, as discussed at step 103, the caspase protein structure can be selected as the reference structure.

At step 109, a residue is selected from the molecular structure. The reference structure typically includes a plurality of residues, and one of the residues is selected for further examination. Each residue is processed in turn.

At step 112, the binding mode for the molecular structure is characterized for the selected residue. In other words, the selected residue is examined to determine whether it is an interacting residue. A residue is denoted as being an interacting residue if the residue has at least one atom that is close to an atom in the molecular structure. An interacting threshold determines the requisite degree of closeness for denoting an interacting threshold. If the inter-atomic distance is less than the interacting threshold, the residue is denoted as being an interacting residue. The interacting threshold can be based on the van der Waals radii of the atoms being used to measure the inter-atomic distance. In an embodiment, the interacting threshold is the product of a scaling factor and the sum of the van der Waals radii of the two atoms. In an embodiment, the value 1.2 is chosen to be the scaling factor.

In an embodiment, a C++ program is executed to calculate the interacting threshold and determine whether the selected residue is an interacting residue. If an interacting residue is detected, the residue is marked or added to a list of interacting residues. In addition to the C++ programming language, other programming languages can be used to code the software for detecting interacting residues.

At step 115, the reference structure is examined to detect any additional residues that are to be characterized. If another residue is detected, the control flow returns to step 109 and the detected residue is examined. If no other residues are detected, the control flow passes to step 118 because all residues have been examined and measured for interactivity with the molecular structure.

At step 118, a residue fingerprint for the molecular structure is produced from the interacting residues. Therefore, a residue fingerprint identifies and/or characterizes a molecular structure by identifying all residues on a reference structure that interact with the molecular structure. In an embodiment, the residue fingerprint is expressed as a list of interacting residues. In another embodiment, the residue fingerprint is represented as a bit string whose length is the number of residues in the reference structure. Positions corresponding to interacting residues receive a “1”, and positions corresponding to non-interacting residues receive a “0” value.

After the residue fingerprint has been produced, the fingerprint is outputted to a storage medium or a display. The residue fingerprint can also be provided as input to another process, computation, or the like. Afterwards, the control flow ends as indicated at step 195.

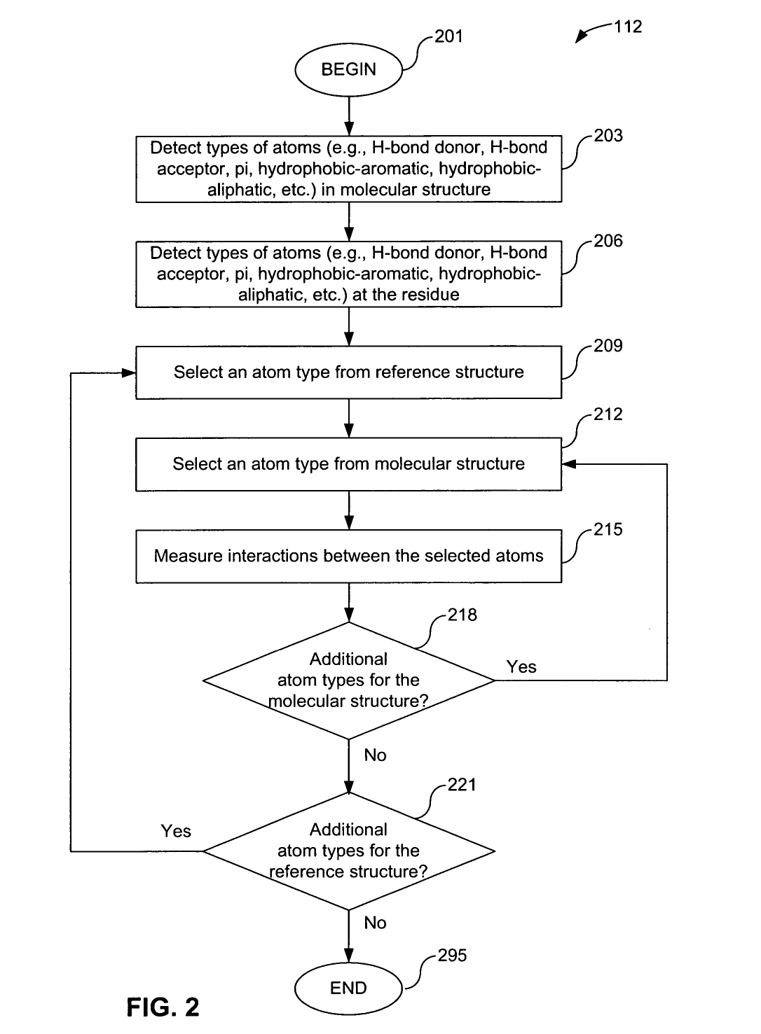

In another embodiment of the present invention, the nature of atom-to-atom interactions is taken into consideration to provide finer granularity to the computation of a residue fingerprint. This can be described with reference to flowchart 112 in FIG. 2, which describes another embodiment of step 112 from FIG. 1. More specifically, flowchart 112 shows another example of a control flow for measuring interaction between a residue and a molecular structure.

The control flow of flowchart 112 begins at step 201 and passes immediately to step 203. At step 203, the atoms of the molecular structure are examined to detect the different types of atoms that are present. The different types can include an H-bond donor, H-bond acceptor, pi, hydrophobic-aromatic, hydrophobic-aliphatic, or the like.

At step 206, the types of atoms are detected at the selected residue for the reference structure. As discussed, the atoms can be an H-bond donor, H-bond acceptor, pi, hydrophobic-aromatic, hydrophobic-aliphatic, or the like.

At step 209, one of the atom types detected at step 206 is selected for the reference structure. At step 212, one of the atom types detected at step 203 for the molecular structure is selected.

At step 215, the atoms corresponding to the selected atom types are examined to determine if the atom from the molecular structure is an interacting atom with respect to the reference structure. As discussed above with reference to step 112, in an embodiment, the inter-atomic distance is measured to determine if the inter-atomic distance is less than an interacting threshold.

At step 218, the molecular structure is examined to detect any additional atom types that have not been examined. If another atom type is detected, the control flow returns to step 212 and the detected atom type is selected. If no other atom types are detected, the control flow passes to step 221 since all detected atom types have been measured for interactivity with the reference structure.

At step 221, the reference structure is examined to detect any additional atom types that have not been examined. If another atom type is detected, the control flow returns to step 209 and the detected atom type is selected. If no other atom types are detected, the control flow passes to step 295 since all detected atom types have been measured for interactivity with the molecular structure. As a result, if five atom types are detectable for both structures, a five-by-five matrix of possible interaction types is defined, and/or a bit can be marked for each interaction that exists between the molecular structure and the reference structure. Afterwards, the control flow ends as indicated at step 295.

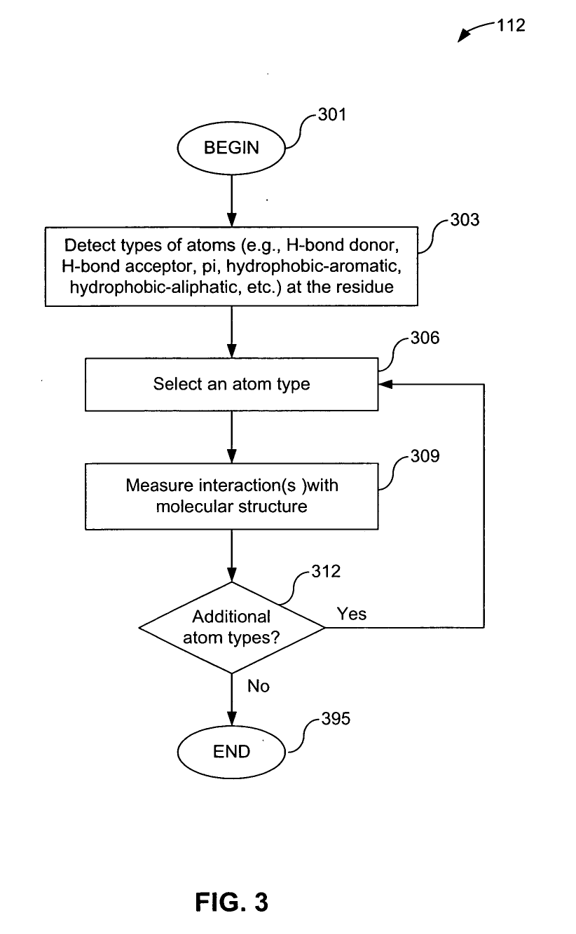

In another embodiment of the present invention, only the types of atoms for the reference structure are taken into consideration to provide finer granularity to the computation of a residue fingerprint. This can be described with reference to flowchart 112 in FIG. 3, which illustrates another embodiment of step 112. More specifically, flowchart 112 shows another example of a control flow for measuring interaction between a residue and a molecular structure.

The control flow of flowchart 112 begins at step 301 and passes immediately to step 303. At step 303, the types of atoms are detected at the selected residue for the reference structure. As discussed above with reference to flowchart 200, the atoms can be an H-bond donor, H-bond acceptor, pi, hydrophobic-aromatic, hydrophobic-aliphatic, or the like.

At step 306, one of the atom types is selected. At step 309, the atoms corresponding to the selected atom type and the atoms from the molecular structure are examined to determine if any atom from the molecular structure is an interacting atom. As discussed above with reference to step 112, in an embodiment, the inter-atomic distance is measured to determine if the inter-atomic distance is less than an interacting threshold.

At step 312, the reference structure is examined to detect any additional atom types that have not been examined. If another atom type is detected, the control flow returns to step 306 and the detected atom type is selected. If no other atom types are detected, the control flow passes to step 395 since all detected atom types have been measured for interactivity with the molecular structure. Afterwards, the control flow ends as indicated at step 395.

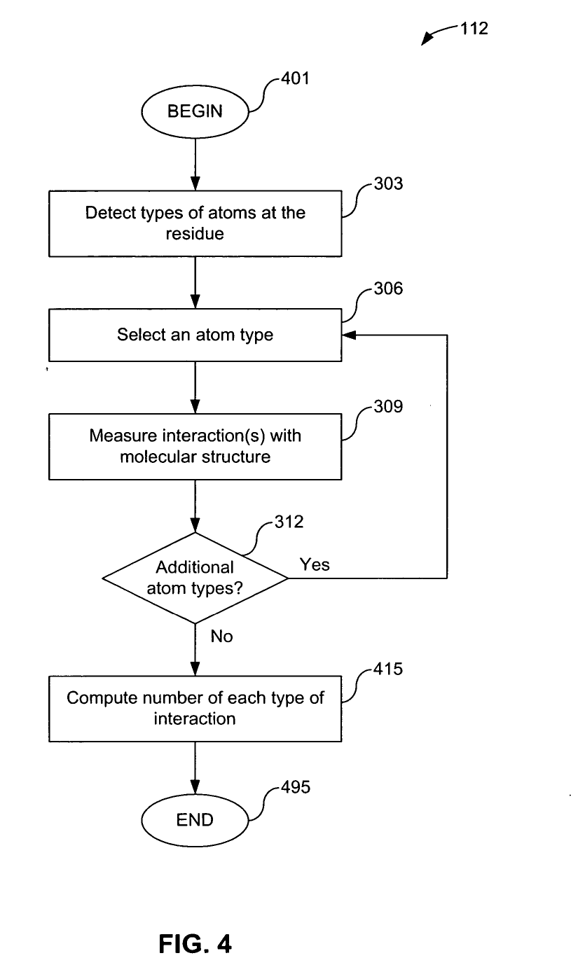

In another embodiment of the present invention, the quantity of each type of interaction with each residue is taken into consideration to increase the granularity for a residue fingerprint. This can be described with reference to flowchart 112 in FIG. 4, which illustrates another embodiment of step 112. More specifically, flowchart 112 shows another example of a control flow for measuring interaction between a residue and a molecular structure.

The control flow of flowchart 112 begins at step 401 and passes immediately to steps 303-312, as described above with reference to FIG. 3. After all detected atom types have been measured for interactivity with the molecular structure, control passes to step 415. At step 415, the number of each type of atom detected and selected at step 303 and step 312 are tallied. Consequently, when the residue fingerprint is computed at step 118, the fingerprint also includes the count of each type of interaction with each residue. The control flow of flowchart 400 ends at step 495.

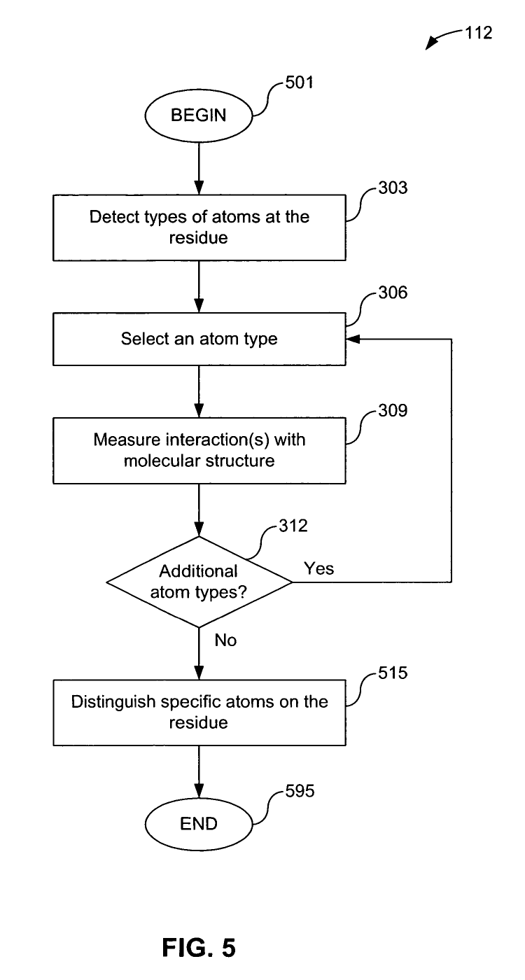

In another embodiment of the present invention, finer granularity to a residue fingerprint is provided to distinguish specific atoms on a residue. This can be described with reference to flowchart 112 in FIG. 5, which illustrates another embodiment of step 112. More specifically, flowchart 112 shows another example of a control flow for measuring interaction between a residue and a molecular structure.

The control flow of flowchart 112 begins at step 501 and passes immediately to steps 303-312, as described above with reference to FIG. 3. After all detected atom types have been measured for interactivity with the molecular structure, control passes to step 515. At step 515, the specific atoms detected and selected at step 303 and step 312 are distinguished. Typically, approximately twenty kinds of residues compose a protein. Each of the twenty kinds has a unique configuration of atoms. For example, the atoms can be CD, CB, etc., or a combination of two or more. At step 515, the identity of each interacting atom in the residue is noted. As a result, when the residue fingerprint is computed at step 118, the fingerprint also includes information that distinguishes the specific atoms on the residues. The control flow ends as indicated at step 595.

As discussed, the control flows depicted in FIGS. 2-5 describe different embodiments of step 112 for measuring interaction between a residue and a molecular structure. Each flowchart describes varying scopes of granularity that accounts for the nature of the interactions. With each embodiment, the residue fingerprint, computed at step 118, is revised to account for the granularity computed at step 112. In an embodiment, the residue fingerprint is expressed as a complete list of interactions by the specific atom in a residue making the interaction, the type of atom in the molecular structure making the interaction, the type of interaction, any other characterizations of the nature of the interactions, or any combination thereof. In another embodiment, a bit string (e.g., 25 bits for each residue) is used to produce a representation of the residue fingerprint. The bit string is likewise inclusive of the characterizations previously listed (e.g., specific atom, type of atom, etc.). In another embodiment, a distinct fingerprint is computed for each possible type of interaction. Then when two molecules are compared, a distinct Tanimoto score is computed for each type of interaction, and a weighted average is computed from the set of Tanimoto scores.

As discussed with reference to step 112 in FIG. 1, a software application can be used to calculate the interacting threshold for each residue, detect interacting residues, and produce a list of interacting residues. The list of interacting residues of the reference structure is published for each of a given set of molecular structures. This gives a compact description of a binding mode for the molecular structures.

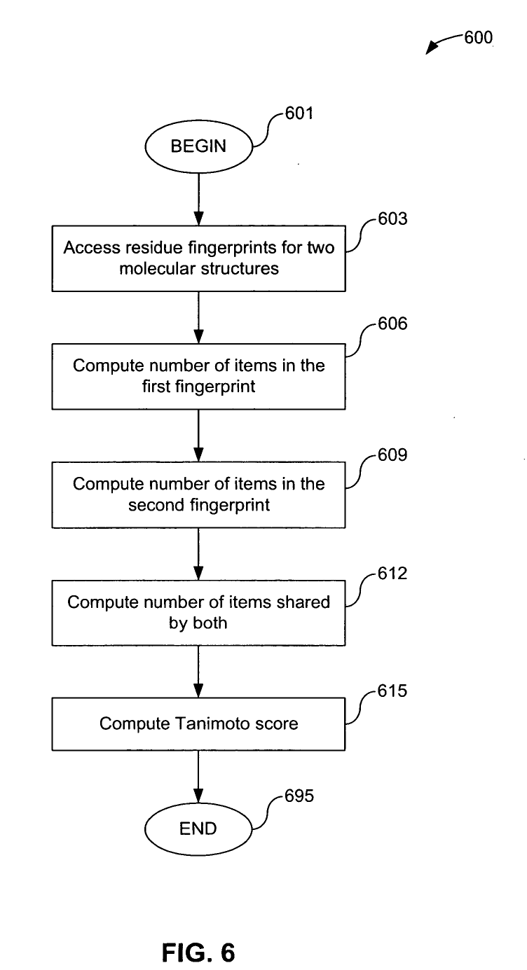

The present invention also includes methodologies and/or techniques for quantifying the similarity of two molecular structures and selecting a subset of maximally dissimilar (i.e., representative) molecular structures. This can be described with reference to FIG. 6. In FIG. 6, flowchart 600 represents the general operational flow of an embodiment of the present invention. More specifically, flowchart 600 shows an example of a control flow for measuring the similarity of two molecular structures.

The control flow of flowchart 600 begins at step 601 and passes immediately to step 603. At step 603, the residue fingerprints for two molecular structures are accessed. The residue fingerprints can be calculated by one or more of the control flows described above with reference to FIG. 1-FIG. 5.

At step 606, one of the residue fingerprints is selected and the number of items in the selected fingerprint is computed. This number is denoted by the variable “N1.” At step 609, the other residue fingerprint is selected and the number of items is computed. This number is denoted by the variable “N2.”

At step 612, the number of items shared by both fingerprints is computed. This number is denoted by the variable “NS.”

At step 615, a Tanimoto score is computed from the information computed from steps 606-612. In an embodiment, the Tanimoto score is computed by summing the number of items from the first and second fingerprints and subtracting the number of shared items from this value. Afterwards, the reciprocal of this value is multiplied by the number of shared items. In other words, “Tanimoto Score=NS/(N1+N2−NS).” After the Tanimoto score is computed, the control flow ends as indicated at step 695.

Computing the Tanimoto score between two residue fingerprints gives a measure of the similarity of the three-dimensional binding modes of the two molecular structures, without regard to their chemical compositions. This similarity measure between two fingerprints forms the basis for various clustering methods.

Thus, in an embodiment, the present invention enables molecular structures to be clustered by binding mode. The Tanimoto score is used to classify a large set of molecular structures into a set of clusters. Molecules within each cluster of molecular structures have a high Tanimoto score to each other and, therefore, a similar binding mode. A representative molecular structure is selected from each cluster. Thus, a small subset of molecular structures can be selected to represent the full diversity of binding modes in a larger set of molecular structures.

In an embodiment, a software application is used to select representative subsets of molecular structures based on their diversity of binding modes. The software application can be the SUBSET program written by Bruno Bienfait and described in the article written by Reynalds et al., entitled “Lead Discovery Using Stochastic Cluster Analysis (SCA): A New Method for Clustering Structurally Similar Compounds,” Journal of Chemical Information and Computer Sciences (1998), vol. 38(2), pp. 305-312, which is incorporated herein by reference in its entirety. The software application can present a small number (e.g., a dozen) of representative molecular structures that reflect the binding modes of the larger set. Then, another software application would select molecular structures similar in binding mode to interesting looking molecular structures. Another software application can also select molecular structures that have interactions with at least a specified set of residues.

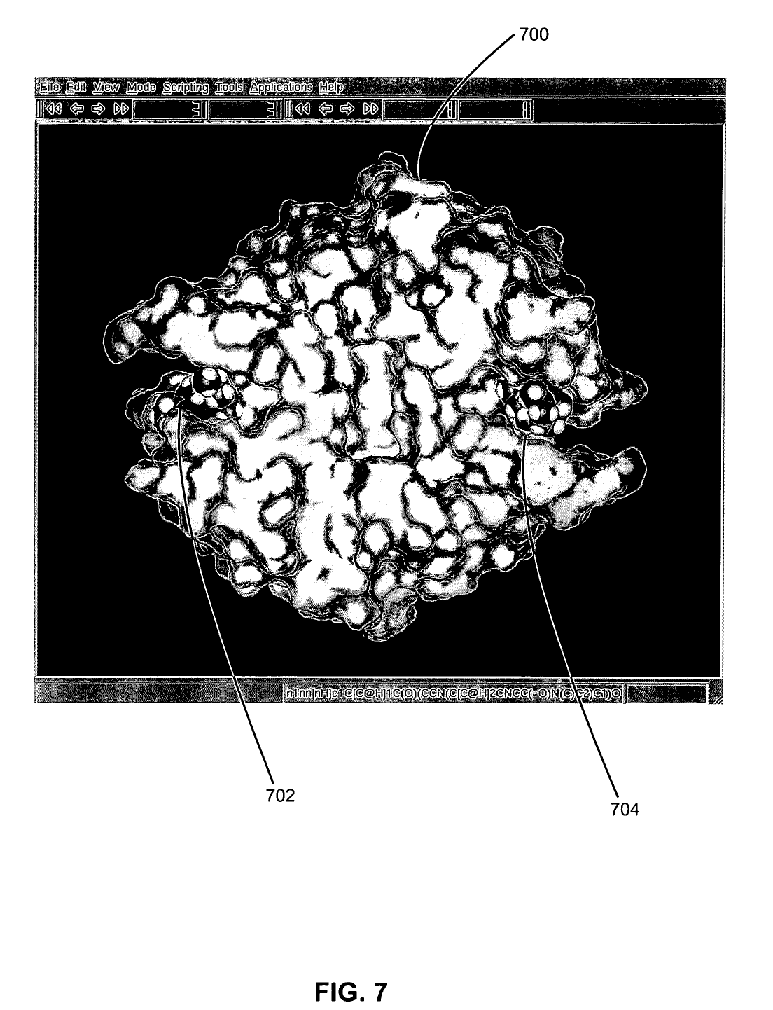

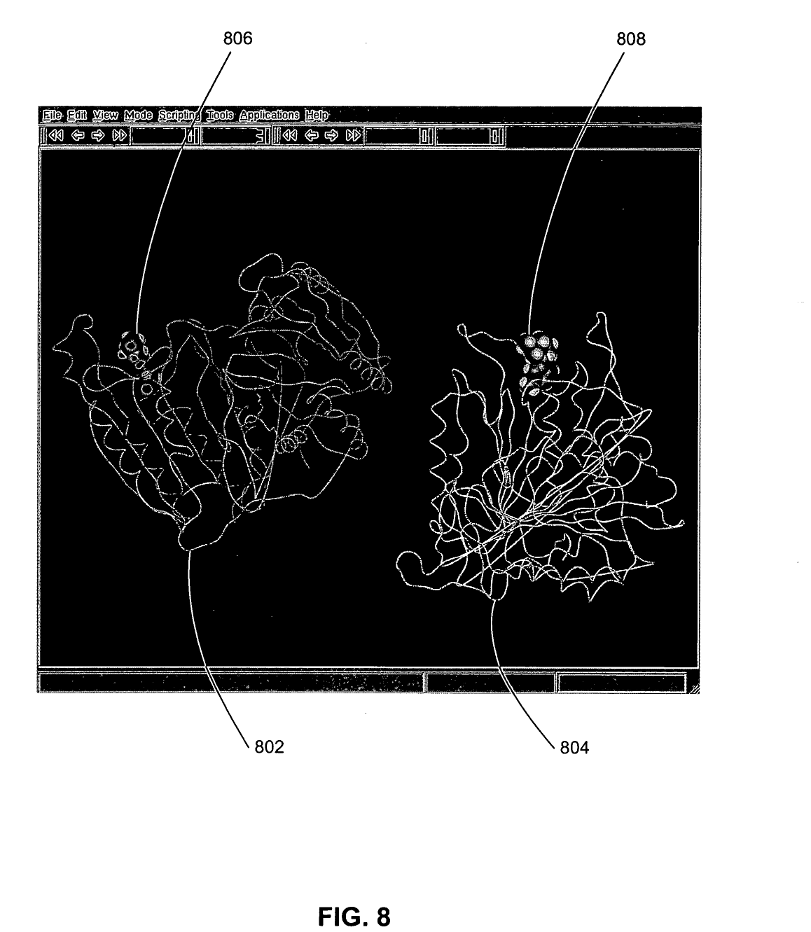

The residue fingerprints of the present invention enable comparisons to be made among the binding modes in symmetrical sites in the same protein complex, or across different but related proteins. FIG. 7 and FIG. 8 provides examples of each type of comparison.

FIG. 7 illustrates a caspase-3 protein dimer structure 700, which includes two analogous binding sites 702 and 704. Binding sites 702 and 704 are theoretically equivalent, but differ in details of their three-dimensional x-ray structures. This can be exploited by considering the residue fingerprinting techniques discussed above.

First, a software application, as discussed above, is used to generate two sets of molecules, one set for each of the two binding sites 702 and 704. Next, residue fingerprints are produced to compare the molecules designed for each site 702 and 704. For each of the two sets of molecules, a molecule is selected having thee-dimensional coordinates that are different from the three-dimensional coordinates of the molecule selected from the other set. Afterwards, a list of interacting residues is assembled for the two molecules from their respective residue fingerprints. For the first molecule, the list of interacting residues includes “A121, A161, A163, A62, A63, A64, A65, E204, E205, E206, E207, E209, and E256.” For the second molecule, the list of interacting residues includes “B121, B161, B162, B163, B62, B64, F204, F205, F206, and F207.” The Tanimoto score for these two molecules is zero, which suggests that the molecules are dissimilar.

However, by discarding the first character (e.g., A, E, B, F) at each site in the residue fingerprint, a list of interacting residues can be prepared that is independent of chain. The Tanimoto score for the independent list is 0.64, which indicates that the molecules are similar despite having different three-dimensional coordinates. The molecules are binding the same way although, by happenstance, they bind to different sites by design. Thus, their similarities can be detected despite being bound at different sites. Accordingly, the residue fingerprints of the present invention enables molecules to be compared across different, yet theoretically equivalent, sites within the same protein complex.

FIG. 8 illustrates a comparison of residue fingerprints in symmetrical sites across different but related proteins 802 and 804, according to an embodiment of the present invention. Protein structure 802 is a caspase-3 protein dimer structure, which includes a binding site 806. Protein structure 804 is a caspase-8 protein dimer structure, which includes a binding site 808. Using a software application, as discussed above, a set of molecules is generated for each of the two binding sites 806 and 808. From each set, a molecule is selected having three-dimensional coordinates that are different from the three-dimensional coordinates of the molecule selected from the other set. A residue fingerprint for the molecule selected for binding site 806 includes the following interacting residues: “B120, B121, B161, B162, B163, B61, B62, B64, F205, and F207.” A residue fingerprint for the molecule selected for binding site 808 includes the interacting residues “C258, C260, C316, C317, C358, C359, C360, D411, and D413.” The Tanimoto score computed for the two molecules is zero, which suggests that the molecules are dissimilar.

By mapping the coordinates of protein structure 802 onto protein structure 804, or vice versa, a merged protein structure can be created to indicate the structural correspondence of the residues between protein structure 802 and protein structure 804. The residue fingerprints for the two molecules would, likewise, indicate the structural correspondence of the residues. For instance, the residue fingerprint for the molecule selected for binding site 806 includes interacting residues “120_{—}316, 121_{—}317, 161_{—}358, 162_{—}359, 163_{—}360, B61, B62, 64_{—}260, 205_{—}411, and 207_{—}413.” The underscores in the residue fingerprint identify the residue sites that are structurally equivalent in the two protein structures 802 and 804. For example, residue site “B120” in protein structure 802 and residue site “C316” in protein structure 804 are structural equivalents, and are, therefore, expressed as a “merged” residue site “120_{—}316” in the residue fingerprint for the merged protein. Residue site “B61” in protein structure 802 does not have a corresponding site in protein structure 804, and therefore, is listed as residue site “B61” in the merged protein.

As for the molecule selected for binding site 808, the residue fingerprint for this molecule includes interacting residues “C258, 64_{—}260, 120_{—}316, 121_{—}317, 161_{—}358, 162_{—}359, 163_{—}360, 205_{—}411, and 207_{—}413.” Once again, the underscores in the residue fingerprint identify the residue sites that are structurally equivalent in the two protein structures 802 and 804. For example, residue site “B64” in protein structure 802 structurally corresponds to residue site “C260” in protein structure 804. However, residue site “C258” in protein structure 804 has no corresponding residue site in protein structure 802.

A Tanimoto score of “0.73” is computed from the “merged” residue fingerprints. The merged Tanimoto score indicates that the two molecules are similar despite having different three-dimensional coordinates and despite being bound to different, but related, protein structures 802 and 804. Therefore, residue fingerprinting, produced in accordance with the present invention, can be extended to allow a comparison to be made among the binding modes of molecules against different, but related, protein structures. By mapping the protein structures to a common location, as discussed above, a protein-neutral list of interacting residues can be generated to compare the binding modes of the molecules designed for different protein structures. The results from the comparison reveal the degree of similarity even though the molecules have different three-dimensional coordinates and bind to different protein structures.

FIGS. 1-8 are conceptual illustrations allowing an explanation of the present invention. It should be understood that embodiments of the present invention could be implemented in hardware, firmware, software, or a combination thereof. In such an embodiment, the various components and steps would be implemented in hardware, firmware, and/or software to perform the functions of the present invention. That is, the same piece of hardware, firmware, or module of software could perform one or more of the illustrated blocks (i.e., components or steps).

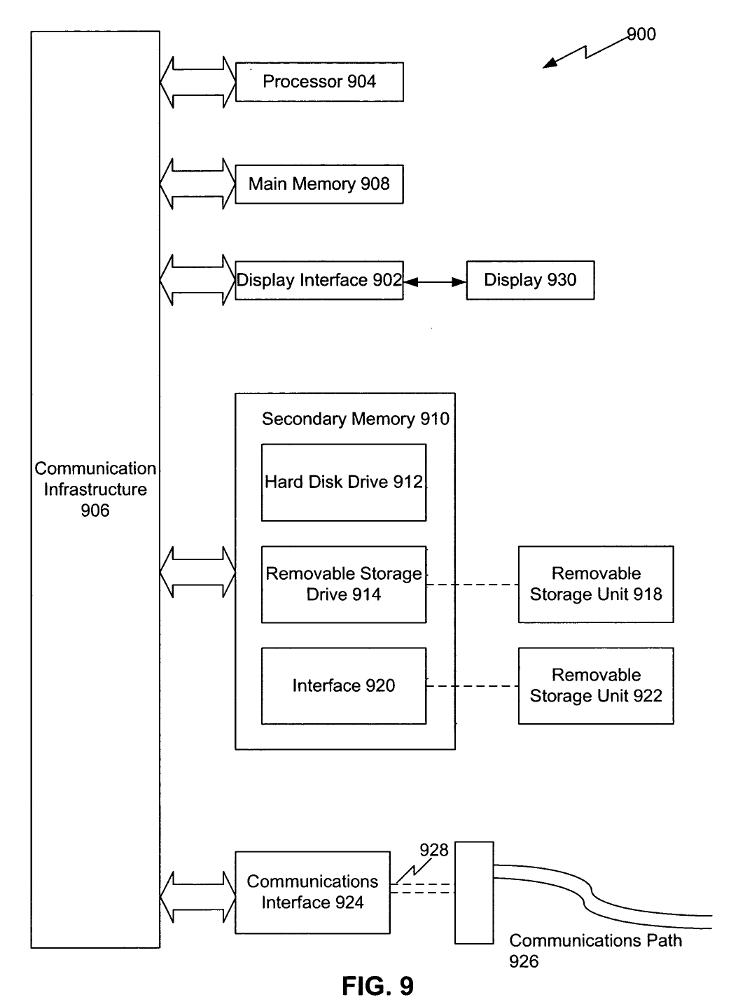

The present invention can be implemented in one or more computer systems capable of carrying out the functionality described herein. Referring to FIG. 9, an example computer system 900 useful in implementing the present invention is shown. Various embodiments of the invention are described in terms of this example computer system 900. After reading this description, it will become apparent to one skilled in the relevant art(s) how to implement the invention using other computer systems and/or computer architectures.

The computer system 900 includes one or more processors, such as processor 904. The processor 904 is connected to a communication infrastructure 906 (e.g., a communications bus, crossover bar, or network).

Computer system 900 can include a display interface 902 that forwards graphics, text, and other data from the communication infrastructure 906 (or from a frame buffer not shown) for display on the display unit 930.

Computer system 900 also includes a main memory 908, preferably random access memory (RAM), and can also include a secondary memory 910. The secondary memory 910 can include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc. which is read by and written to removable storage drive 914. As will be appreciated, the removable storage unit 918 includes a computer usable storage medium having stored therein computer software (e.g., programs or other instructions) and/or data.

In alternative embodiments, secondary memory 910 can include other similar means for allowing computer software and/or data to be loaded into computer system 900. Such means can include, for example, a removable storage unit 922 and an interface 920. Examples of such can include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to computer system 900.

Computer system 900 can also include a communications interface 924. Communications interface 924 allows software and data to be transferred between computer system 900 and external devices. Examples of communications interface 924 can include a modem, a network interface (such as an Ethernet card), a communications port, a PCMCIA slot and card, etc. Software and data transferred via communications interface 924 are in the form of signals 928 which can be electronic, electromagnetic, optical, or other signals capable of being received by communications interface 924. These signals 928 are provided to communications interface 924 via a communications path (i.e., channel) 926. Communications path 926 carries signals 928 and can be implemented using wire or cable, fiber optics, a phone line, a cellular phone link, an RF link, free-space optics, and/or other communications channels.

In this document, the terms “computer program medium” and “computer usable medium” are used to generally refer to media such as removable storage unit 918, removable storage unit 922, a hard disk installed in hard disk drive 912, and signals 928. These computer program products are means for providing software to computer system 900. The invention is directed to such computer program products.

Computer programs (also called computer control logic or computer readable program code) are stored in main memory 908 and/or secondary memory 910. Computer programs can also be received via communications interface 924. Such computer programs, when executed, enable the computer system 900 to implement the present invention as discussed herein. In particular, the computer programs, when executed, enable the processor 904 to implement the processes of the present invention, such as the various steps of methods 100 and 600, for example, described above. Accordingly, such computer programs represent controllers of the computer system 900.

In an embodiment where the invention is implemented using software, the software can be stored in a computer program product and loaded into computer system 900 using removable storage drive 914, hard drive 912, interface 920, or communications interface 924. The control logic (software), when executed by the processor 904, causes the processor 904 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to one skilled in the relevant art(s).

In yet another embodiment, the invention is implemented using a combination of both hardware and software.

The foregoing description of the specific embodiments will so fully reveal the general nature of the invention that others can, by applying knowledge within the skill of the art (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It will be apparent to one skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

1. A method of identifying a three-dimensional molecular structure, comprising:
accessing a computer readable representation of a reference structure having a plurality of residues;
calculating interaction between said plurality of residues and the molecular structure; and
producing a residue fingerprint based on said interaction to identify the molecular structure.

2. The method according to claim 1, wherein said calculating step comprises:
computing inter-atomic distance between the molecular structure and a residue from said plurality of residues; and
denoting said residue as an interacting residue when the inter-atomic distance is less than a predetermined threshold.

3. The method according to claim 2, wherein said producing step comprises:
identifying said interacting residue in said residue fingerprint.

4. The method according to claim 2, further comprising:
deriving said predetermined threshold from the van der Waals radius of an atom from the molecular structure.

5. The method according to claim 2, wherein said computing step comprises:
computing inter-atomic distance between at least one atom of the molecular structure and at least one atom of said residue.

6. The method according to claim 1, wherein said producing step comprises:
generating a binary representation of a listing of interacting residues from said plurality of residues to, thereby, produce said residue fingerprint, each interacting residue having an inter-atomic distance from the molecular structure less than a predetermined threshold.

7. The method according to claim 1, further comprising:
comparing each type of atom in the molecular structure with each type of atom in a residue from said plurality of residues to detect an interacting residue having an inter-atomic distance below a predetermined threshold.

8. The method according to claim 1, further comprising:
comparing the molecular structure with each type of atom in a residue from said plurality of residues to detect an interacting residue having an inter-atomic distance below a predetermined threshold.

9. The method according to claim 1, further comprising:
comparing the molecular structure with each type of atom in a residue from said plurality of residues to detect an interacting residue having an inter-atomic distance below a predetermined threshold;
computing the number of each type of interaction; and
including, in said residue fingerprint, a listing of interacting residues and an associated number of each type of interaction.

10. The method according to claim 1, further comprising:
comparing the molecular structure with each type of atom in a residue from said plurality of residues to detect an interacting residue having an inter-atomic distance below a predetermined threshold;
distinguishing the specific atoms on said interacting residue; and
including, in said residue fingerprint, a listing of interacting residues and the associated specific atoms for each interacting residue.

11. The method according to claim 1, further comprising:
calculating interaction between said plurality of residues and a second molecular structure to produce a second residue fingerprint; and
computing the similarity between the molecular structure and said second molecular structure based on said residue fingerprint and said second residue fingerprint.

12. A method of identifying a plurality of three-dimensional molecular structures, comprising:
accessing a reference structure having a plurality of residues;
calculating interaction between said plurality of residues and (each of the plurality of molecular structures; and
producing a plurality of residue fingerprints based on said interaction, each residue fingerprint characterizing a corresponding molecular structure from the plurality of molecular structures.

13. The method according to claim 12, further comprising:
classifying the plurality of molecular structures into clusters based on said plurality of residue fingerprints, each cluster of molecular structures having a similar binding mode.

14. The method according to claim 13, further comprising:
computing a Tanimoto score among the molecular structures in each cluster of the plurality of molecular structures, wherein each pair of structures within a cluster of molecular structures has a similar Tanimoto score.

15. A computer program product comprising a computer useable medium having computer readable program code functions embedded in said medium for causing a computer to identify a three-dimensional molecular structure, comprising:
a first computer readable program code function that causes the computer to access a reference structure having a plurality of residues;
a second computer readable program code function that causes the computer to calculate interaction between said plurality of residues and the molecular structure; and
a third computer readable program code function that causes the computer to produce a residue fingerprint based on said interaction to identify the molecular structure.

16. The computer program product according to claim 15, wherein said second computer readable program code function comprises:
a fourth computer readable program code function that causes the computer to detect an interacting residue having a distance between the molecular structure and said residue below a predetermined threshold, wherein said residue fingerprint includes a listing of interacting residues.

17. The computer program product according to claim 15, further comprising:
a fourth computer readable program code function that causes the computer to create a binary representation of a listing of interacting residues from said plurality of residues to, thereby, produce said residue fingerprint, wherein each interacting residue has an inter-atomic distance from the molecular structure less than a predetermined threshold.
